(19) United States
(12) Patent Application Publication
(10) Pub. No.: US 2010/0057500 A1
(43) Pub. Date: Mar. 4, 2010

(54) SYSTEM AND METHOD FOR MEDIATING ADMISSION FO FOREIGN EDUCATION AGENCY

(76) Inventor: Kwon-Tack Lim, Jeon Buk Province (KR)

Correspondence Address: MAXON IP LLC, 22458 PINE RIDGE COURT, ASHBURN, VA, 20148, US

(21) Appl. No.: 12/594,199

(22) PCT Filed: Apr. 2, 2008
(86) PCT No.: PCT/KR08/01857

§ 371 Date: Oct. 1, 2009

(30) Foreign Application Priority Data
Apr. 2, 2007 (KR) 10-2007-0032395

(51) Int. Cl. G06Q 50/00; G06Q 40/00; G06Q 30/00; G06Q 20/00; G06Q 10/00

(52) U.S. Cl. 705/4; 705/34; 705/40; 705/327

(57) ABSTRACT

A domestic mediation server receives information of application for education from a user, provides offer information of domestic and foreign agents or education institutions, and is informed of at least one agent or education institution. In the case that the user selects an agent, the domestic mediation server receives a detailed information for entrance of education institutions corresponding to the application information from the agent. The detailed entrance information is ranked in order of matching with the application information and provided to the user. When the user determines to enter a specific education institution, the agent charges the user education expenses including an entrance fee of the education institution and its commission. When the user settles the education expenses, the user is provided with an insurance policy for guaranteeing safe settlement. Subsequently, when the user completes registration for entrance, the education expenses are transferred to the education institution and the agent.

### TECHNICAL FIELD

The present invention relates to system and method for mediating foreign education, and in particular, to a system for mediating foreign education that informs domestic and foreign education agents and foreign education institutions of a user's application for foreign education using domestic and foreign mediation servers, mediates the user's entrance to a foreign education institution through the mediation servers, and delivers education expenses to the foreign education institution on condition that registration of entrance is checked, and a method for mediating foreign education.

### BACKGROUND ART

Recently, the number of students who go abroad to study in foreign education institutions is increasing. In such an environment, it is most important that the students determine the country and an education institution appropriate for their educational objects, follow necessary procedures for entrance to the determined education institution and complete an education course.

There are many education institutions in the world depending on an education course selected by a user, however it is difficult for the user to sufficiently acquire information about education institutions and determine an appropriate education institution. This is because most of agents or mediation sites suggest the user only education institutions limited to a specific country. In other words, the agents or mediation sites suggest the user only products that are advantageous to themselves, and thus the user selects a specific education institution without full and sufficient information about education institutions appropriate for his/her educational object.

Further, some users having relatively insufficient information about foreign education institutions inquire for foreign education institutions through agents or mediation sites and entrust education expenses including an entrance fee to the agents or mediation sites, but some vicious agents or mediation sites provide an insincere service and take a commission, or in worse case, run a paper company, advertise for students and abscond with a commission.

### DISCLOSURE OF INVENTION

### Technical Problem

The present invention is designed to solve the above-mentioned problems, and therefore it is an object of the present invention to provide a service for mediating foreign education, which connects a user desirous of foreign education with domestic and foreign agents for providing information about foreign education and mediating entrance to a foreign education institution through domestic and foreign servers, when the user selects a specific agent and determines to enter a specific education institution, temporarily keeps an entrance fee of the user, and provides the entrance fee to the corresponding education institution per the user's request.

### Technical Solution

In order to achieve the above-mentioned object, a method for mediating foreign education according to the present invention (first embodiment), in which mediation servers built inside and outside of the country mediate foreign education admission and education expense payment between a user, an agent and an education institution using a wire or wireless network, comprises (SA10) a domestic mediation server receiving information of application for education from a user terminal, providing the user terminal with offer information of domestic and foreign agents or education institutions in order of matching with the application information, and being informed of at least one agent or education institution selected by a user; in the case that the user selects an agent in the step (SA10), (SA20) receiving detailed information for entrance of education institutions corresponding to the application information from an agent terminal selected by the user and storing the detailed entrance information in a DB; (SA30) evaluating the detailed entrance information, ranking the detailed entrance information in order of matching with the application information to generate a list of classified education institutions, and providing the user terminal with the list; (SA40) receiving selection of a specific education institution from the user terminal inquired out the list of classified education institutions and informing the corresponding agent terminal of the user's determination of entrance; (SA50) receiving details of education expenses including an entrance fee of the education institution determined by the user and a commission from the agent terminal, and informing the user terminal of the details of education expenses; and (S60) when the user connects to an affiliated bank server and settles the education expenses, the domestic mediation server providing the user terminal with an insurance policy, and when a foreign mediation server is informed of the user's registration for entrance from the education institution, the foreign mediation server requesting the affiliated bank server to transfer the education expenses to accounts of the education institution and the agent corresponding to the user.

According to a preferred feature of the present invention, the step (SA10) includes (SA11) a domestic mediation server receiving information of application for education from a user terminal connected to a homepage and storing the application information into a DB; (SA12) providing the application information to agent terminals and education institution terminals registered in the server; (SA13) receiving offer information including at least one education institution from agent terminals inquired out the application information and storing the offer information into a DB; (SA14) receiving offer information from at least one education institution inquired out the application information and storing the offer information into a DB; (SA15) the domestic mediation server evaluating the offer information of the steps (S 13) and (S 14), ranking the offer information in order of matching with the application information to generate a list of classified agents and a list of classified education institutions, and providing the user terminal with the lists; and (SA16) receiving selection of at least one agent or education institution from the user terminal and informing the corresponding agent or education institution of the user's selection.

Preferably, in the case that the user selects an education institution in the step (SA10), the method comprises (SA21) receiving a detailed information for entrance from an education institution terminal selected by the user and storing the detailed entrance information into a DB; (SA41) receiving the user's determination of entrance from the user terminal inquired out the detailed entrance information and informing the corresponding education institution terminal of the user's determination of entrance; and (SA51) receiving details of education expenses from the education institution and informing the user terminal of the details of education expenses.

In order to achieve the above-mentioned object, a method for mediating foreign education according to the present invention (second embodiment), in which mediation servers built inside and outside of the country mediate foreign education admission and education expense payment between a user, an agent and an education institution using a wire or wireless network, comprises (SB10) a domestic mediation server receiving information of application for education from a user terminal, providing the user terminal with offer information of agents in order of matching with the application information, and being informed of at least one agent selected by a user; (SB20) the domestic mediation server mediating consultation between an agent terminal selected by the user and the user terminal through a homepage, receiving a detailed information for entrance from the agent terminal, and transmitting the detailed entrance information to a homepage of a foreign mediation server to register the detailed entrance information in the homepage of the foreign mediation server; (SB30) the foreign mediation server receiving an offer information corresponding to the detailed entrance information from education institution terminals, ranking the offer information in order of matching with the application information to generate a list of classified education institutions, and providing the list to the agent terminal and the user terminal through the domestic mediation server; (SB40) the domestic mediation server receiving selection of a specific education institution in the list of classified education institutions from the user terminal, informing the corresponding agent terminal of the user's determination of entrance, receiving application for entrance to the education institution determined by the user from the agent terminal and transmitting the entrance application to the foreign mediation server; (SB50) the foreign mediation server receiving details of education expenses from an education institution terminal inquired out the entrance application and registering the details of education expenses in the domestic mediation server; (SB51) the domestic mediation server receiving registration of a commission in addition to the education expenses from the agent terminal checked the details of education expenses and informing the user terminal of the details of education expenses; and (S60) when the user connects to an affiliated bank server and settles the education expenses, the domestic mediation server providing the user terminal with an insurance policy, and when the foreign mediation server is informed of the user's registration for entrance from the education institution, the foreign mediation server requesting the affiliated bank server to transfer the education expenses to accounts of the education institution and the agent corresponding to the user.

According to a preferred feature of the present invention, the step (SB10) includes (SB11) a domestic mediation server receiving information of application for education from a user terminal connected to a homepage and storing the application information into a DB; (SB12) providing the application information to agent terminals registered in the server; (SB13) receiving offer information including at least one education institution from agent terminals inquired out the application information and storing the offer information into a DB; (SB14) the domestic mediation server evaluating the offer information, ranking the offer information in order of matching with the application information to generate a list of classified agents, and providing the user terminal with the list; and (SB15) when receiving selection of at least one agent from the user terminal, informing a corresponding agent terminal of the user's selection.

In order to achieve the above-mentioned object, a method for mediating foreign education according to the present invention (third embodiment), in which mediation servers built inside and outside of the country mediate foreign education admission and education expense payment between a user, an agent and an education institution using a wire or wireless network, comprises (SC 10) a domestic mediation server receiving information of application for education from a user terminal, the domestic mediation server and a foreign mediation server providing agent terminals and education institution terminals with the application information, providing the user terminal to offer information of domestic and foreign agents and education institutions in order of matching with the application information, and being informed of at least one agent or education institution selected by a user; in the case that the user selects an agent in the step (SC10), (SC20) the domestic mediation server mediating consultation between an agent terminal selected by the user and the user terminal through a homepage, receiving a detailed information for entrance from the agent terminal, and transmitting the detailed entrance information to a homepage of the foreign mediation server to register the application information in the homepage of the foreign mediation server; (SC30) the foreign mediation server receiving offer information corresponding to the application information registered in the homepage from education institution terminals, ranking the offer information in order of matching with the application information to generate a list of classified education institutions, and providing the list to the agent terminal and the user terminal through the domestic mediation server; (SC40) the domestic mediation server receiving selection of a specific education institution in the list of classified education institutions from the user terminal, informing the corresponding agent terminal of the user's determination of entrance, receiving application for entrance to the education institution determined by the user from the agent terminal, and transmitting the entrance application to the foreign mediation server; (SC50) the foreign mediation server receiving details of education expenses from an education institution terminal inquired out the entrance application and registering the details of education expenses in the domestic mediation server; (SC51) the domestic mediation server receiving registration of a commission in addition to the education expenses from the agent terminal checked the details of education expenses and informing the user terminal of the details of education expenses; and (SC60) when the user connects to an affiliated bank server and settles the education expenses, the domestic mediation server providing the user terminal with an insurance policy, and when the foreign mediation server is informed of the user's registration for entrance from the education institution, the foreign mediation server requesting the affiliated bank server to transfer the education expenses to accounts of the education institution and the agent corresponding to the user.

According to a preferred feature of the present invention, the domestic mediation server receives the application information including country, region, the name of an education institution, an education course, education expenses, a term and a dormitory from the user terminal, and stores the application information in a DB.

Preferably, the step (SC 10) includes (SC11) the domestic mediation server receiving information of application for education from a user terminal connected to a homepage and storing the application information into a DB; (SC12) the domestic mediation server providing the application information to agent terminals registered in the server; (SC13) a foreign mediation server receiving the application information from the domestic mediation server using a homepage, and providing the application information to agent terminals and education institution terminals registered in the server; (SC14) the domestic mediation server receiving offer information corresponding to the application information from the agent terminals of the steps (SC12) and (SC13); (SC15) the domestic mediation server receiving offer information corresponding to the application information from the education institution terminals; and (SC16) the domestic mediation server providing the user terminal to the offer information of the steps (SC14) and (SC15) in order of matching with the application information and being informed of at least one agent or education institution selected by a user.

Preferably, in the case that the user selects an education institution in the step (SC10), the method comprises (SC21) the domestic mediation server informing the foreign mediation server of an education institution selected by the user, and the foreign mediation server receiving a detailed information for entrance from an education institution terminal selected by the user and storing the detailed entrance information into a DB; (SC41) the domestic mediation server receiving the detailed entrance information from the foreign mediation server and storing the detailed entrance information into a DB, and when receiving determination of entrance from the user terminal inquired out the detailed entrance information, informing the corresponding education institution of the user's determination of entrance through the foreign mediation server; and (SC52) the foreign mediation server receiving details of education expenses from the education institution terminal and informing the user terminal of the details of education expenses through the domestic mediation server.

Preferably, the step (S60) includes (S61) when the domestic mediation server is informed of the user's settlement from an affiliated bank server, the domestic mediation server requesting an affiliated insurance agency to send an insurance policy, providing the user terminal with the insurance policy and informing the foreign mediation server and the agent terminal of the user's settlement; (S62) when the user completes registration for entrance in the education institution, the foreign mediation server receiving a request to settle the education expenses from the education institution terminal; (S63) the foreign mediation server requesting the bank server to calculate and settle the education expenses to accounts of the education institution and the agent corresponding to the user; and (S64) the foreign mediation server being informed from the bank server that settlement is completed.

Meanwhile, in order to achieve the above-mentioned object, a system for mediating foreign education of the present invention, in which mediation servers built inside and outside of the country mediate foreign education admission and education expense payment in a wire or wireless network environment, comprises a user terminal for inputting information of application for education, selecting a mediation service using an agent through a domestic mediation server or a direct service through an education institution to determine entrance, and when settling education expenses, receiving guarantee of the education expenses on condition of completion of registration for entrance; a domestic mediation server for mediating foreign education admission by receiving the application information from the user terminal through a homepage, receiving offer information corresponding to the application information from registered agents or education institutions, providing the user terminal with an agent list or education institution list, in which the offer information is ranked in order of matching with the application information, receiving selection of at least one agent or education institution from a user and providing the user terminal with an entrance fee information; a foreign mediation server for receiving the application information from the domestic mediation server, registering the application information in a homepage, providing the application information to registered agents or education institutions, being informed from the domestic mediation server that the education expenses are settled, and when being informed from an education institution that registration for entrance is completed, requesting to calculate and transfer the education expenses to accounts of the education institution and an agent; an agent terminal for receiving the application information through each of the homepages, registering a corresponding offer information in the domestic mediation server, being informed of an agent selected by the user from the domestic mediation server, providing information for entrance of an education institution selected by the user, and when the user determines entrance, registering details of corresponding education expenses in the domestic mediation server; and an education institution terminal for receiving the application information through the foreign mediation server, registering a corresponding offer information, and when the user completes registration for entrance, requesting the foreign mediation server to transfer the education expenses.

### BRIEF DESCRIPTION OF THE DRAWINGS

The present invention will be more fully described in the following detailed description, taken accompanying drawings, however, the description proposed herein is just a preferable example for the purpose of illustrations, not intended to limit the scope of the invention. In the drawings:

FIG. 1 is a network configuration of a system for mediating foreign education according to the present invention.

FIG. 2 is a schematic block diagram of a domestic mediation server according to an embodiment of the present invention.

FIG. 3 is a schematic block diagram of a foreign mediation server according to an embodiment of the present invention.

FIGS. 4 to 6 are flow charts of a method for mediating foreign education according to a first embodiment, a second embodiment and a third embodiment of the present invention, respectively.

### BEST MODE FOR CARRYING OUT THE INVENTION

### 1. System Configuration

### 1.1 Configuration of System

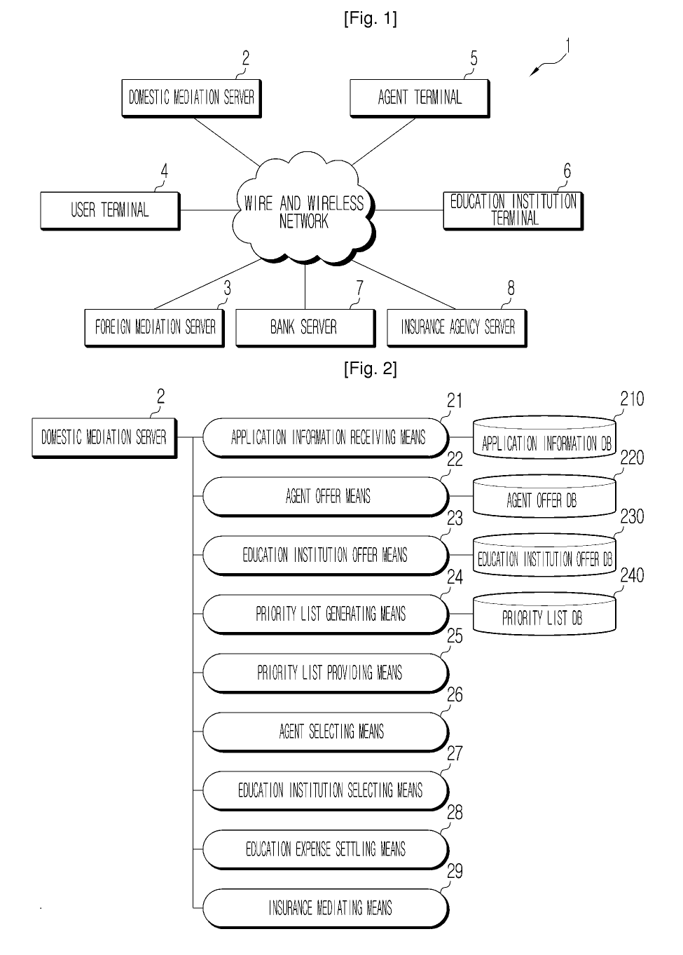

FIG. 1 is a network configuration of a system 1 for mediating foreign education according to the present invention.

The mediation system 1 according to the present invention is built based on a wire or wireless network communication, and comprises a domestic mediation server 2 and a foreign mediation server 3 for mediating foreign education between a user, an agent and an education institution, a user terminal 4 for applying for foreign education, an agent terminal 5 for mediating information exchange between a user and an education institution, and an education institution terminal 6 for admitting application for foreign education of a user and an agent. To mediate safe settlement of education expenses, the mediation system 1 further comprises a bank server 7 for receiving education expenses from a user and temporarily keeping the education expenses until registration for entrance is completed, and an insurance agency server 8 for guaranteeing safe settlement of education expenses to a user.

A mediation service of foreign education according to the present invention provides users inquiring about entrance to foreign education institutions for the purpose of studying abroad, learning foreign language, acquiring a certificate of qualification or taking an education course with information about entrance to a foreign education institution and mediates registration for entrance to the users. Here, in consideration of differences in language and education/culture between interested parties, i.e. users and foreign education institutions, the mediation system 1 builds the domestic mediation server 2 for providing users with a guide interface and the foreign mediation server 3 for providing education institutions with a guide interface. And, the servers 2 and 3 are built by the same provider or in business affiliation with each other by the same provider, and the domestic mediation server 2 provides users with a mediation service and the foreign mediation server 3 provides education institutions with a mediation service. Some users who have difficulty in directly consulting with education institutions may be informed of many agents suggesting education products, select a specific agent and receive a mediation service from the selected agent.

The present invention provides a safe settlement service to prevent the likelihood that a user may be swindled or provided with an insufficient service when the user is provided with a service through an agent or an education institution. The safe settlement is made using a certified bank in business affiliation with the domestic mediation server 2. The bank receives education expenses from the user, temporarily keeps the education expenses, and calculates and transfers the education expenses to an education institution or an agent on condition that it is checked the user completed registration for entrance in the education institution. Further, when it is checked the user settled the education expenses, an insurance agency inputs automatically a security insurance of the user and issues an insurance policy.

The domestic mediation server 2 has a homepage, and receives information of application for education from the user terminal 4 and transmits the application information to the agent terminal 5 and the education institution terminal 6. Here, the application information includes country, region, the name of an education institution, an education course, education expenses, a term or a dormitory that the user wishes. And, the application information is also registered in a homepage of the foreign mediation server 3, and can be inquired out by the foreign agent terminal 5 and the foreign education institution terminal 6. The agent terminal 5 and the education institution terminal 6 receive the application information through the servers 2 and 3, and register offer information in the domestic mediation server 2. The offer information is evaluated based on the application information of the user, ranked according to priority, and transmitted to the user terminal 4. The user receives a list, in which the offer information is ranked according to priority based on the application information, selects a specific agent, and requests a mediation service to the agent or selects a specific education institution and directly applies for entrance.

When the user determines an education institution intended to enter, the domestic mediation server 2 informs the user of education expenses, and when it is checked the user settled the education expenses, the bank server 7 mediates an insurance of the user through the insurance agency server 8 and transmits an insurance policy to the user terminal 4.

The foreign mediation server 3 receives the application information of the user or a detailed information of entrance inputted by agents through the domestic mediation server 2, and registers the information in the homepage. The agents or education institutions inquire out the information registered in the homepage and input offer information, and the offer information is provided to the user terminal 2 through the domestic mediation server 2. And, if the user directly completes registration for entrance in an education institution, the user receives a request to settle education expenses from the education institution terminal 6 and requests the bank terminal 7 to transfer the education expenses.

The user terminal 4 inputs the application information into the homepage of the domestic mediation server 2 and receives the offer information ranked in order of matching with his/her application information. After the user receives the offer information, the user selects at least one agent or education institution and consults with the agent or education institution. Through the consultation, the user selects a final agent or education institution and requests for entrance. Therefore, the user can select an education institution appropriate for his/her educational object.

The agent terminal 5 receives the application information through the domestic mediation server 2 and the foreign mediation server 3, and registers a corresponding offer information. The offer information may be registered only by agents signed up for the servers 2 and 3 according to a service policy, however the present invention is not limited in this regard. An agent receives the application information from the servers 2 and 3, but registers the offer information in the domestic mediation server 2.

This is for the convenience of the domestic mediation server 2 providing a guide interface to the user. When an agent selected by the user receives selection of an education institution through consultation with the user, the agent transmits the details of education expenses including a commission and an entrance fee to the domestic mediation server 2 thereby to request the user to settle the education expenses. Then, after the user completes registration for entrance, the agent receives the commission.

The education institution terminal 6 receives the application information through the domestic mediation server 2 and the foreign mediation server 3 in the same route as the agent terminal 5, and registers a corresponding offer information. The offer information may be also registered only by education institutions signed up for the servers 2 and 3 according to a service policy. An education institution receives the application information from the servers 2 and 3, but registers the offer information in the domestic mediation server 2. This is for the convenience of the domestic mediation server 2 providing a guide interface to the user. When an education institution selected by the user is informed of determination of entrance through consultation with the user, the education institution transmits the details of education expenses to the domestic mediation server 2 thereby to request the user to settle the education expenses. Then, when the user visits the corresponding education institution and completes registration for entrance, the education institution requests the foreign mediation server 3 to settle the education expenses, and receives the education expenses.

The bank server 7 is connected with the user terminal 4 and receives the education expenses settled by the user. After the education expenses are settled, the bank server 7 informs the domestic mediation server 2 of settlement of the education expenses, and the domestic mediation server 2 informs the foreign mediation server 3 of settlement of the education expenses. The agent or education institution is informed of the user's settlement of the education expenses from the servers 2 and 3, respectively. And, when the bank server 7 receives a request to settle the education expenses through the foreign mediation server 3, the bank server 7 transfers the commission to an account of the agent and the education expenses to an account of the education institution. And, in the case that the domestic mediation server 2 and the foreign mediation server 3 charge for their services, the charges of the servers 2 and 3 are included in the education expenses and calculated and settled.

The insurance agency server 8 receives a request to input an insurance from the domestic mediation server 2 that is informed of the user's settlement of the education expenses, and in response to the request, transacts an automatic input of insurance and issues an insurance policy.

### 1.2 Configuration of Domestic Mediation Server

FIG. 2 is a schematic block diagram of the domestic mediation server 2 according to an embodiment of the present invention.

To provide an offer information suitable for the application information of the user, the domestic mediation server 2 according to an embodiment of the present invention includes an application information receiving means 21 for receiving an application information of a user, an agent offer means 22 for receiving an offer information of an agent, an education institution offer means 23 for receiving an offer information of an education institution, a priority list generating means 24 for evaluating the offer information in order of matching with the application information of the user to generate a list, and a priority list providing means 25 for providing the list.

And, to receive selection of a final education institution from the user, the domestic mediation server 2 further includes an agent selecting means 26 for receiving selection of an agent from the user, an education institution selecting means 27 for receiving selection of an education institution from the user, an education expense settling means 28 for receiving a request for the user to settle education expenses and informing the user of the request, and an insurance mediating means 29 for mediating an insurance of the user.

The application information receiving means 21 receives an application information through the homepage from the user terminal 4, and stores the application information into an application information DB (database) 210. The agent terminal 5 and the education institution terminal 6 may connect to the homepage to inquire out the application information, and receive the application information through e-mail according to selection.

The agent offer means 22 receives an offer information corresponding to the application information from the agent terminal 5 through the homepage, and stores the offer information into an agent offer DB 220. The offer information includes information about at least one education institution recommended by an agent.

The education institution offer means 23 receives an offer information corresponding to the application information from the education institution terminal 6 through the homepage, and stores the offer information into an education institution offer DB 230. The offer information includes information about education facilities or education courses of an education institution.

The priority list generating means 24 evaluates the offer information stored in the agent offer DB 220 and the education institution offer DB 230 according to items of the application information inputted by the user. After evaluation, the priority list generating means 24 ranks the offer information in order of points calculated numerically according to the extent of matching with the application information. The ranked offer information is generated into a priority list including a list of classified agents and a list of classified education institutions.

The priority list providing means 25 provides the user terminal 4 with the priority list through the homepage. The user can select an agent or education institution among agents or education institutions displayed in order of matching with his/her application information in the priority list.

The agent selecting means 26 receives selection of at least one agent from the user terminal 4 examined the priority list through the homepage. Here, selection of an agent means that the user wants to receive further information about an education institution intended to enter actually from the selected agent. Accordingly, the user should pay a commission to the agent.

The education institution selecting means 27 receives selection of at least one education institution from the user terminal 4 examined the priority list through the homepage. Here, selection of an education institution means that the user determines entrance or the user wants to make a deep consultation for a final determination. Accordingly, the selected education institution informs the user of a detailed information including an entrance fee.

When the user determines entrance through consultation with the selected agent and education institution, the education expense settling means 28 receives a request to settle the education expenses from the agent or education institution and informs the user of the request. And, when the user connects to the bank server 7 to settle the education expenses per the request, the education expense settling means 28 is informed of the user's settlement. Here, in the case that the user determined entrance through an agent, the education expense settling means 28 receives the details of education expenses including all sorts of commissions and an entrance fee from the agent terminal 5. On the contrary, in the case that the user determined entrance through an education institution, the education expense settling means 28 receives the details of education expenses including an entrance fee from the education institution terminal 6.

When the insurance mediating means 29 is informed of the user's settlement, the insurance mediating means 29 connects to the insurance agency server 8 to request an insurance of the user. The insurance agency server 8 guarantees the education expenses settled by the user and issues an insurance policy. And, the user terminal 4 is informed that the insurance policy was issued through the domestic mediation server 2.

### 1.3 Configuration of Foreign Mediation Server

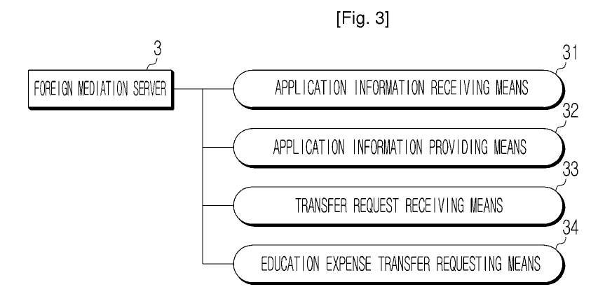

FIG. 3 is a schematic block diagram of the foreign mediation server 3 according to an embodiment of the present invention.

The foreign mediation server 3 according to an embodiment of the present invention includes an application information receiving means 31 for receiving an application information from the domestic mediation server 2 and registering the application information in the homepage, an application information providing means 32 for providing agents or education institutions with the application information registered in the homepage, a transfer request receiving means 33 for receiving a request to transfer education expenses from an education institution, and an education expense transfer requesting means 34 for informing the bank server 7 of the transfer request of the education institution and requesting the bank server 7 to transfer the education expenses.

### 2. Method Configuration

The method for mediating foreign education according to a preferred embodiment of the present invention can be implemented through construction of the above-mentioned system 1 for mediating foreign education.

### 2.1 Mediation Method of First Embodiment

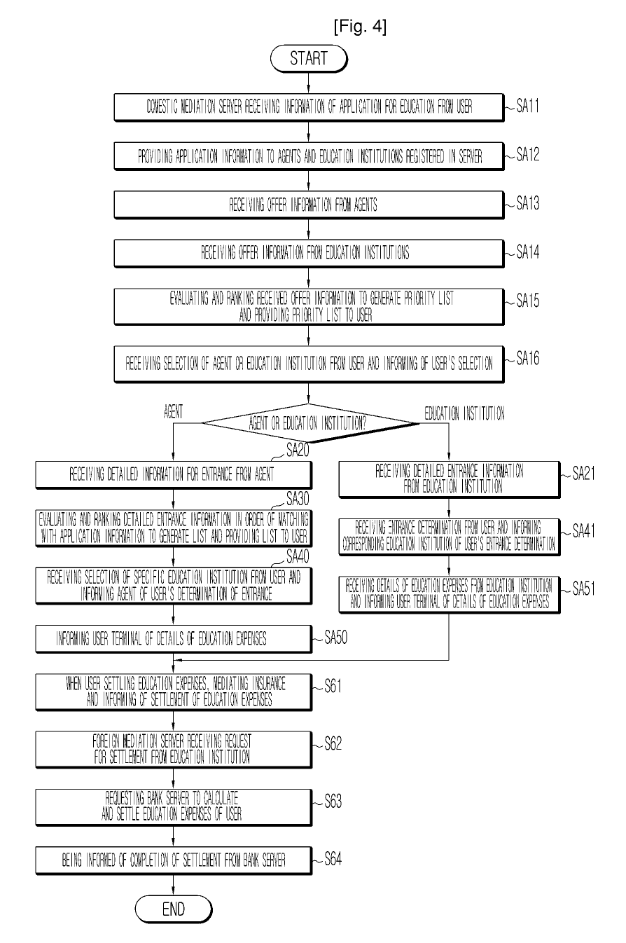

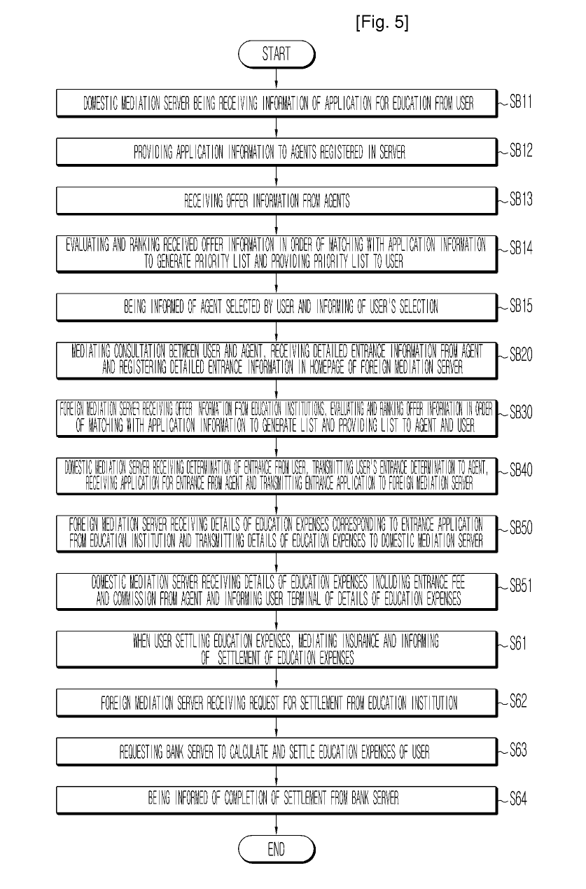

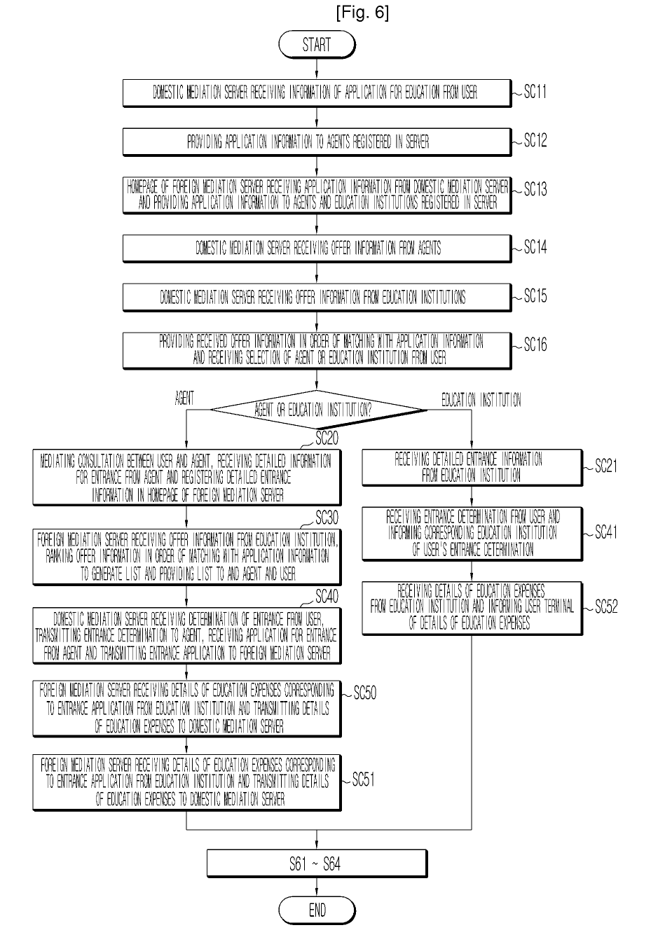

FIG. 4 is a flow chart of a method for mediating foreign education according to a first embodiment of the present invention.

According to the first embodiment, the domestic mediation server 2 provides registered agents and education institutions with information of application for education of a user, informs the user that the user should settle education expenses when the user determines an education institution, and when the user completes registration for entrance in the education institution, provides a service for transferring the education expenses to the education institution.

The domestic mediation server 2 receives the application information including country, region, the name of an education institution, an education course, education expenses, a term or a dormitory from the user terminal 4 through the homepage, and stores the application information into the application information DB 210 (SA11). When the application information is registered, agents and education institutions registered in the domestic mediation server 2 inquire out the application information (SA12) and register corresponding offer information (SA13 and SA14). When the offer information is registered, the domestic mediation server 2 ranks the offer information of domestic and foreign agents or education institutions in order of matching with the application information to generate a priority list, and registers the priority list in the homepage to provide the user with an inquiry service (SA15). The user terminal 4 examines the priority list and selects at least one agent or education institution (SA16). The selected agent or education institution provides a full consulting service through the homepage.

Here, assuming that the user selects an agent. After the agent terminal 5 is informed of the user's selection, the agent terminal 5 registers a detailed information for entrance in the homepage (SA20). The domestic mediation server 2 evaluates the detailed entrance information and ranks the detailed entrance information in order of matching with the application information of the user to generate a priority list, and the user receives recommended education institutions appropriate for the application information through the priority list (SA30). The user selects a specific education institution intended to enter among the recommended education institutions and requests to mediate entrance (SA40). The domestic mediation server 2 provides the agent terminal 5 with the user's determination of entrance, and the agent terminal 5 registers education expenses including a commission and an entrance fee in the homepage (SA50).

If the user selects an education institution, the domestic mediation server 2 informs the education institution terminal 6 of the user's selection, and receives a detailed information for entrance from the education institution terminal 6 through the homepage (SA21). The user inquires out the detailed entrance information and makes a final determination of entrance, and the education institution is informed of the user's determination of entrance through the domestic mediation server 2 (SA41). The education institution registers information about education expenses including an entrance fee in the homepage, and the user terminal 4 inquires out the information about education expenses (SA51).

The user is provided with a settlement page from the domestic mediation server 2 and inputs a settlement information including a credit card number or an account number according to a notice about the education expenses, and the settlement information is transmitted to the bank server 7. The user may connect to the bank server 7 and directly settle the education expenses. The domestic mediation server 2 is informed that settlement is completed from the bank server 7 which transacted the settlement (S61). The domestic mediation server 2 informs the foreign mediation server 3, the agent terminal 5 and the education institution terminal 6 that settlement is completed. Subsequently, the user is provided with a visa service from the agent according to settlement of the education expenses, and leaves to visit the education institution and completes registration for entrance. When registration for entrance is completed, the education institution terminal 6 transmits a request for settlement of the education expenses to the foreign mediation server 3 (S62), and the foreign mediation server 3 extracts a bank information from the notified information about the user's settlement and requests the corresponding bank server 7 to calculate and settle the education expenses (S63). In the case that the user selects an agent, a commission is calculated as a fee for the agent, and an entrance fee is calculated as a fee for the education institution among the education expenses. The bank server 7 settles the education expenses to the agent or education institution. When the domestic mediation server 2 is informed from the bank server 7 that settlement is completed, the domestic mediation server 2 informs the insurance agency server 8 of the expiry of the insurance (S64).

### 2.2 Mediation Method of Second Embodiment

FIG. 5 is a flow chart of a method for mediating foreign education according to a second embodiment of the present invention.

According to the second embodiment, the domestic mediation server 2 provides only registered agents with information of application for education of a user, and the agents input a detailed information for entrance to advertise for education institutions through the foreign mediation server 3. The user selects a specific education institution in the domestic mediation server 2, determines to enter the education institution and settles education expenses. And, when the user completes registration for entrance in the education institution, the foreign mediation server 2 provides a service for transferring the education expenses to the education institution.

The domestic mediation server 2 receives the application information from the user terminal 4 through the homepage, and stores the application information into the application information DB 210 (SB1). When the application information is registered, agents registered in the domestic mediation server 2 inquire out the application information (SB12) and register corresponding offer information (SB13). When the offer information is registered, the domestic server 2 generates a priority list, in which the offer information of domestic and foreign agents are ranked in order of matching with the application information, and registers the priority list in the homepage to provide the user with an inquiry service (SB14). The user terminal 4 examines the priority list and selects at least one agent, and the agent terminal 5 is informed of the user's selection (SB15).

The notified agent terminal 5 registers a detailed information for entrance in the homepage of the domestic mediation server 3, and the detailed entrance information is also registered in the homepage of the foreign mediation server 3 (SB20). The foreign mediation server 3 provides the education institution terminal 6 with the detailed entrance information, receives corresponding offer information, evaluates at least one offer information, ranks the offer information in order of matching with the application information of the user to generate a priority list, and transmits the priority list to the domestic mediation server 2. And, the agent and the user examine the priority list through the domestic mediation server 2 (SB30). The domestic mediation server 2 receives the user's determination to enter a specific education institution from the user examined the priority list and transmits the user's determination to the agent terminal 5, and the agent terminal 5 fills out an application form to register application for entrance (SB40). The education institution inquired out application for entrance through the foreign mediation server 3 registers the details of education expenses including an entrance fee, and the foreign mediation server 3 transmits the details of education expenses to the domestic mediation server 2 (SB50). The agent terminal 5 registers a commission in addition to the details of education expenses received through the domestic mediation server 2, and the user is informed of the details of education expenses through the domestic mediation server 2 (SB51).

A subsequent process is the same as the settlement process (S61 to S64) of the first embodiment, and thus its detailed description is herein omitted.

### 2.3 Mediation Method of Third Embodiment

According to the third embodiment, each of the domestic mediation server 2 and the foreign mediation server 3 provides their registered agents with information of application for education of a user. And, the foreign mediation server 3 provides education institutions with the application information. The agents or education institutions register offer information corresponding to the application information, and the user is provided with the offer information, selects an agent or education institution and settles education expenses.

The domestic mediation server 2 receives the application information from the user terminal 4 through the homepage and registers the application information in the application information DB 210 (SC11). When the application information is registered, agents registered in the domestic mediation server 2 inquire out the application information (SC12). The domestic mediation server 2 registers the application information in the homepage of the foreign mediation server 3, and the agents and education institutions registered in the server 3 inquire out the application information (SC13). Subsequently, the domestic mediation server 2 receives offer information from the agents or education institutions registered in each of the servers 2 and 3 (SC14 and SC15). The registered offer information is generated into a priority list in the domestic mediation server 2, registered in the homepage of the domestic mediation server 2, and provided to the user for an inquiry service. The user terminal 4 examines the priority list, selects at least one agent and education institution, and the corresponding agent terminal 5 or education institution 6 is informed of the user's selection (SC16). The user selects whether to select an agent and receive a consulting service or to compare directly education institutions and determine to enter a specific education institution.

First, assuming that the user selects an agent. After the agent terminal 5 is informed of the user's selection, the agent terminal 5 registers a detailed information for entrance in the homepage, and the registered detailed entrance information is transmitted to the homepage of the foreign mediation server 3 (SC20). The education institutions register offer information corresponding to the detailed entrance information in the homepage, and the offer information is generated into a priority list, in which the offer information is ranked in order of matching with the application information, and provided to the agent and the user through the foreign mediation server 3 and the domestic mediation server 2 (SC30). The domestic mediation server 2 receives selection of a specific education institution intended to enter among the recommended education institutions from the user and provides the selection of a specific education institution to the agent terminal 5. When the agent fills out an application form, the application form is transmitted to the foreign mediation server 3 through the domestic mediation server 2 (SC40). After the education institution inquires out the application for entrance through the foreign mediation server 3, the education institution registers education expenses including an entrance fee, and the foreign mediation server 3 transmits the details of education expenses to the domestic mediation server 2 (SC50). The agent terminal 5 registers a commission in addition to the details of education expenses received through the domestic mediation server 2, and the user is informed of the details of education expenses through the domestic mediation server 2 (SC51).

If the user selects an education institution, the domestic mediation server 2 informs the education institution terminal 6 of the user's selection and receives a detailed information for entrance from the education institution terminal 6 through the homepage (SC21). The user inquires out the detailed entrance information and finally determines to enter the education institution, and the education institution is informed of the user's determination of entrance through the domestic mediation server 2 (SC41). The education institution registers information about education expenses including an entrance fee in the homepage, and the user terminal 4 inquires out the information about education expenses (SC52).

A subsequent process is the same as the settlement process (S61 to S64) of the first embodiment, and thus its detailed description is herein omitted.

Described above are the embodiments of the system and method for mediating foreign education according to the present invention. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the system and method for mediating foreign education of the present invention, servers built inside and outside of the country recommend a user foreign education agents and foreign education institutions according to matching with conditions of application for education, when the user determines to enter a specific education institution, receives settlement of education expenses, keeps the education expenses, and provides the education expenses to an agent and the education institution on condition that the user's registration for entrance in the education institution is check.

What is claimed is:

1. A method for mediating admission of foreign education agency, in which mediation servers built inside and outside of the country mediate foreign education admission and education expense payment between a user, an agent and an education institution using a wire or wireless network, the method comprising:
(SA10) a domestic mediation server receiving information of application for education from a user terminal, providing the user terminal with offer information of domestic and foreign agents or education institutions in order of matching with the application information, and being informed of at least one agent or education institution selected by a user;
in the case that the user selects an agent in the step (SA10), (SA20) receiving a detailed information for entrance of education institutions corresponding to the application information from an agent terminal selected by the user, and storing the detailed entrance information in a DB;
(SA30) evaluating the detailed entrance information, ranking the detailed entrance information in order of matching with the application information to generate a list of classified education institutions, and providing the user terminal with the list;
(SA40) receiving selection of a specific education institution from the user terminal inquired out the list of classified education institutions and informing the corresponding agent terminal of the user's determination of entrance;
(SA50) receiving details of education expenses including an entrance fee of the education institution determined by the user and a commission from the agent terminal, and informing the user terminal of the details of education expenses; and
(S60) when the user connects to an affiliated bank server and settles the education expenses, the domestic mediation server providing the user terminal with an insurance policy, and when a foreign mediation server is informed of the user's registration for entrance from the education institution, the foreign mediation server requesting the affiliated bank server to transfer the education expenses to accounts of the education institution and the agent corresponding to the user.

2. The method for mediating admission of foreign education agency according to claim 1, wherein the step (SA10) includes:
(SA11) the domestic mediation server receiving information of application for entrance from a user terminal connected to a homepage and storing the application information into a DB;
(SA12) providing the application information to agent terminals and education institution terminals registered in the domestic mediation server;
(SA13) receiving offer information including at least one education institution from agent terminals inquired out the application information and storing the offer information into a DB;
(SA14) receiving offer information from at least one education institution inquired out the application information and storing the offer information into a DB;
(SA15) the domestic mediation server evaluating the offer information of the steps (S13) and (S14), ranking the offer information in order of matching with the application information to generate a list of classified agents and a list of classified education institutions, and providing the user terminal with the lists; and
(SA16) receiving selection of at least one agent or education institution from the user terminal and informing the corresponding agent or education institution of the user's selection.

3. The method for mediating admission of foreign education agency according to claim 1, wherein, in the case that the user selects an education institution in the step (SA10), the method comprises:
(SA21) receiving a detailed information for entrance from an education institution terminal selected by the user and storing the detailed entrance information into a DB;
(SA41) receiving the user's determination of entrance from the user terminal inquired out the detailed entrance information and informing the corresponding education institution terminal of the user's determination of entrance; and
(SA51) receiving details of education expenses from the education institution and informing the user terminal of the details of education expenses.

4. A method for mediating admission of foreign education agency, in which mediation servers built inside and outside of the country mediate foreign education admission and education expense payment between a user, an agent and an education institution using a wire or wireless network, the method comprising:
(SB10) a domestic mediation server receiving information of application for education from a user terminal, providing the user terminal with offer information of agents in order of matching with the application information, and being informed of at least one agent selected by a user;
(SB20) the domestic mediation server mediating consultation between an agent terminal selected by the user and the user terminal through a homepage, receiving a detailed information for entrance from the agent terminal, and transmitting the detailed entrance information to a homepage of a foreign mediation server to register the detailed entrance information in the homepage of the foreign mediation server;
(SB30) the foreign mediation server receiving offer information corresponding to the detailed entrance information from education institution terminals, ranking the offer information in order of matching with the application information to generate a list of classified education institutions, and providing the list to the agent terminal and the user terminal through the domestic mediation server;
(SB40) the domestic mediation server receiving selection of a specific education institution in the list of classified education institutions from the user terminal, informing the corresponding agent terminal of the user's determination of entrance, receiving application for entrance to the education institution determined by the user from the agent terminal and transmitting the entrance application to the foreign mediation server;
(SB50) the foreign mediation server receiving details of education expenses from an education institution terminal inquired out the entrance application and registering the details of education expenses in the domestic mediation server;
(SB51) the domestic mediation server receiving registration of a commission in addition to the education expenses from the agent terminal checked the details of education expenses and informing the user terminal of the details of education expenses; and
(S60) when the user connects to an affiliated bank server and settles the education expenses, the domestic mediation server providing the user terminal with an insurance policy, and when the foreign mediation server is informed of the user's registration for entrance from the education institution, the foreign mediation server requesting the affiliated bank server to transfer the education expenses to accounts of the education institution and the agent corresponding to the user.

5. The method for mediating admission of foreign education agency according to claim 4, wherein the step (SB10) includes:
(SB11) the domestic mediation server receiving information of application for entrance from a user terminal connected to a homepage and storing the application information into a DB;
(SB12) providing the application information to agent terminals registered in the domestic mediation server;
(SB13) receiving offer information including at least one education institution from agent terminals inquired out the application information and storing the offer information into a DB;
(SB14) the domestic mediation server evaluating the offer information, ranking the offer information in order of matching with the application information to generate a list of classified agents, and providing the user terminal with the list; and
(SB15) when receiving selection of at least one agent from the user terminal, informing a corresponding agent terminal of the user's selection.

6. A method for mediating admission of foreign education agency, in which mediation servers built inside and outside of the country mediate foreign education admission and education expense payment between a user, an agent and an education institution using a wire or wireless network, the method comprising:
(SC10) a domestic mediation server receiving information of application for education from a user terminal, the domestic mediation server and a foreign mediation server providing agent terminals and education institution terminals with the application information, providing the user terminal to offer information of domestic and foreign agents and education institutions in order of matching with the application information, and being informed of at least one agent or education institution selected by a user;
in the case that the user selects an agent in the step (SC10), (SC20) the domestic mediation server mediating consultation between an agent terminal selected by the user and the user terminal through a homepage, receiving a detailed information for entrance from the agent terminal and transmitting the detailed entrance information to a homepage of the foreign mediation server to register the application information in the homepage of the foreign mediation server;
(SC30) the foreign mediation server receiving offer information corresponding to the application information registered in the homepage from education institution terminals, ranking the offer information in order of matching with the application information to generate a list of classified education institutions, and providing the list to the agent terminal and the user terminal through the domestic mediation server; (SC40) the domestic mediation server receiving selection of a specific education institution in the list of classified education institutions from the user terminal, informing the corresponding agent terminal of the user's determination of entrance, receiving application for entrance to the education institution determined by the user from the agent terminal, and transmitting the entrance application to the foreign mediation server;
(SC50) the foreign mediation server receiving details of education expenses from an education institution terminal inquired out the entrance application, and registering the details of education expenses in the domestic mediation server; (SC51) the domestic mediation server receiving registration of a commission in addition to the education expenses from the agent terminal checked the details of education expenses, and informing the user terminal of the details of education expenses; and
(SC60) when the user connects to an affiliated bank server and settles the education expenses, the domestic mediation server providing the user terminal with an insurance policy, and when the foreign mediation server is informed of the user's registration for entrance from the education institution, the foreign mediation server requesting the affiliated bank server to transfer the education expenses to accounts of the education institution and the agent corresponding to the user.

7. The method for mediating admission of foreign education agency according to any one of claims 1, 4 and 6, wherein the domestic mediation server receives the application information including country, region, the name of an education institution, an education course, education expenses, a term and a dormitory from the user terminal, and stores the application information in a DB.

8. The method for mediating admission of foreign education agency according to claim 6, wherein the step (SC10) includes:
(SC11) a domestic mediation server receiving information of application for education from a user terminal connected to a homepage and storing the application information into a DB;
(SC12) providing the application information to agent terminals and education institutions terminals registered in the domestic mediation server;
(SC13) a foreign mediation server receiving the application information from the domestic mediation server using a homepage, and providing the application information to agent terminals and education institution terminals registered in the server; (SC14) the domestic mediation server receiving offer information corresponding to the application information from the agent terminals of the steps (SC12) and (SC13);
(SC15) the domestic mediation server receiving offer information corresponding to the application information from the education institution terminals; and (SC16) the domestic mediation server providing the user terminal to the offer information of the steps (SC14) and (SC15) in order of matching with the application information and being informed of at least one agent or education institution selected by a user.

9. The method for mediating admission of foreign education agency according to claim 6, wherein, in the case that the user selects an education institution in the step (SC10), the method comprises:
(SC21) the domestic mediation server informing the foreign mediation server of an education institution selected by the user, and the foreign mediation server receiving a detailed information for entrance from an education institution terminal selected by the user and storing the detailed entrance information into a DB;
(SC41) the domestic mediation server receiving the detailed entrance information from the foreign mediation server and storing the detailed entrance information into a DB, and when receiving determination of entrance from the user terminal inquired out the detailed entrance information, informing the corresponding education institution of the user's determination of entrance through the foreign mediation server; and
(SC52) the foreign mediation server receiving details of education expenses from the education institution terminal and informing the user terminal of the details of education expenses through the domestic mediation server.

10. The method for mediating admission of foreign education agency according to any one of claims 1, 4 or 6, wherein the step (S60) includes:
(S61) when the domestic mediation server is informed of the user's settlement from an affiliated bank server, the domestic mediation server requesting an affiliated insurance agency to send an insurance policy, providing the user terminal with the insurance policy and informing the foreign mediation server and the agent terminal of the user's settlement;
(S62) when the user completes registration for entrance in the education institution, the foreign mediation server receiving a request to settle the education expenses from the education institution terminal; and
(S63) the foreign mediation server requesting the bank server to calculate and settle the education expenses to accounts of the education institution and the agent corresponding to the user; and
(S64) the foreign mediation server being informed from the bank server that settlement is completed.

11. A system for mediating admission of foreign education agency, in which mediation servers built inside and outside of the country mediate foreign education admission and education expense payment in a wire or wireless network environment, the system comprising:
a user terminal for inputting information of application for education, selecting a mediation service using an agent through a domestic mediation server or a direct service through an education institution to determine entrance, and when settling education expenses, receiving guarantee of the education expenses on condition of completion of registration for entrance;
a domestic mediation server for mediating foreign education admission by receiving the application information from the user terminal through a homepage, receiving offer information corresponding to the application information from registered agents or education institutions, providing the user terminal with an agent list or education institution list, in which the offer information is ranked in order of matching with the application information, receiving selection of at least one agent or education institution from a user and providing the user terminal with an entrance fee information;
a foreign mediation server for receiving the application information from the domestic mediation server, registering the application information in a homepage, providing the application information to registered agents or education institutions, being informed from the domestic mediation server that the education expenses are settled, and when being informed from an education institution that registration for entrance is completed, requesting to calculate and transfer the education expenses to accounts of the education institution and an agent;
an agent terminal for receiving the application information through each of the homepages, registering a corresponding offer information in the domestic mediation server, being informed of an agent selected by the user from the domestic mediation server, providing information for entrance of an education institution selected by the user, and when the user determines entrance, registering details of corresponding education expenses in the domestic mediation server; and
an education institution terminal for receiving the application information through the foreign mediation server, registering a corresponding offer information, and when the user completes registration for entrance, requesting the foreign mediation server to transfer the education expenses.

12. The system for mediating admission of foreign education agency according to claim 11, further comprising:
a bank server for receiving connection of the user terminal by business affiliation with the domestic mediation server, receiving education expenses of the user, keeping the education expenses, when the education expenses are transferred by the user, informing the domestic mediation server that the education expenses are settled, and transferring the education expenses to an account of the corresponding education institution or agent at the request of the foreign mediation server for transfer.

13. The system for mediating admission of foreign education agency according to claim 11 or 12, further comprising: an insurance agency server for, to guarantee the education expenses settled by the user until registration for entrance in the education institution is completed, receiving a request to issue an insurance policy from the domestic mediation server informed that the user settled the education expenses, getting the user to be insured, and issuing the corresponding insurance policy.

14. The system for mediating admission of foreign education agency according to claim 11, wherein the domestic mediation server includes:
means for receiving the application information including country, region, the name of an education institution, an education course, education expenses, a term and a dormitory from the user terminal, and storing the application information in a DB;
means for receiving offer information including at least one education institution corresponding to the application information from registered agent terminals and storing the offer information into a DB;
means for receiving offer information corresponding to the application information from registered education institution terminals and storing the offer information into a DB;
means for ranking each of the offer information in order of matching with the application information and generating an agent list or education institution list;
means for providing the user terminal with the agent list or education institution list.

15. The system for mediating admission of foreign education agency according to claim 14, wherein the domestic mediation server further includes: means for receiving selection of at least one agent or education institution from the user terminal;
means for being informed from a bank server that the user settled the education expenses; and
means for, when settlement of the education expenses is checked, requesting an insurance agency server to issue an insurance policy and providing the insurance policy to the user terminal.

16. The system for mediating admission of foreign education agency according to claim 11, wherein the foreign mediation server includes:
means for receiving the application information from the domestic mediation server, storing the application information in a DB, and providing the application information to registered agents or education institutions; and
means for, when the user's registration for entrance in the education institution is checked, receiving a request to transfer the education expenses from the education institution and transmitting the request to transfer the education expenses to a bank server.
